(19) United States
(12) Patent Application Publication
(10) Pub. No.: US 2025/0250737 A1
(43) Pub. Date: Aug. 7, 2025

(54) BARRIER COMPOSITIONS AND METHOD OF USE

(71) Applicant: SOLENIS TECHNOLOGIES, L.P., Wilmington, DE (US)

(72) Inventors: Ming Liu, Mönchengladbach (DE); Armin Hager, Sommerhausen (DE); Luc Van der Auwera, Krefeld (DE); Patric Bierganns, Kempen (DE)

(73) Assignee: SOLENIS TECHNOLOGIES, L.P., Wilmington, DE (US)

(21) Appl. No.: 19/045,603

(22) Filed: Feb. 5, 2025

Related U.S. Application Data
(60) Provisional application No. 63/550,662, filed on Feb. 7, 2024.

(51) Int. Cl. D06M 13/11; D06M 13/53; D06M 15/05; D06M 15/71; D06M 101/06

(52) U.S. Cl. CPC D06M 13/11; D06M 13/53; D06M 15/05; D06M 15/71; D06M 2101/06; D06M 2200/40

(57) ABSTRACT

Provided is a barrier composition that includes an aqueous dispersion of one or more functional agents, and one or more nanocelluloses. Also provided is a method of improving retention, reactivity, and/or distribution of functional agents disposed on a substrate. The substrate having a substrate surface and comprising a fiber having a fiber surface in which the barrier composition is applied to or disposed on the substrate.

### CROSS-REFERENCE TO RELATED APPLICATIONS

This application claims the benefit of U.S. Provisional application No. 63/550,662, filed 7 Feb. 2024, the entire contents of which are hereby incorporated by reference.

### TECHNICAL FIELD

The present disclosure generally relates to a composition that includes an aqueous dispersion of one or more functional agents formulated with a nanocellulose. Functional agents can be sizing agents, barrier agents, and combinations thereof. Nanocelluloses can be selected from, for example, microfibrillated cellulose (MFC), nanofibrillated cellulose (NFC), microcrystalline cellulose (MCC), nanocrystalline cellulose (NCC), and combinations thereof. The composition can be applied or disposed onto a surface of a substrate leading to a substrate having better retention, reactivity, or distribution of functional agents, on the substrate providing coated articles with enhanced reactivity of cellulose fiber, increased retention of functional agents, and/or improved oil, grease, gas, water, and water vapor barrier properties.

### BACKGROUND

Cellulose fibers in the dry state from dry molding processes lack interactions and reactivity toward sizing agents, such as for example, alkyl ketene dimers (AKD), alkenyl ketene dimers (AnKD), and alkenyl succinic anhydride (ASA). As a result, poor bonding of the AKD, AnKD or ASA to the fiber and inhomogeneity of AKD, AnKD or ASA distributions is seen in the dry molded articles after applying the sizing agents to the dry cellulose fibers. This, in turn, reduces the performance of the sizing agents and other additives when using as a functional barrier composition. In addition, the high portion of unbound AKD, AnKD or ASA in the dry molded article renders the end product to be out of compliance with regulatory requirements, for example, when the article is being used in food contact applications.

To improve the retention of a functional agent, such as a sizing agent or barrier agent, to a substrate, work was begun to increase the interaction and reactivity of formulations used in applications such as dry molding processes. It soon became evident that formulations containing nanocellulose could be used as carrier agents for sizing agents in dry molding processes.

In fact, it was observed that by combining one or more nanocelluloses, such as microfibrillated cellulose (MFC), nanofibrillated cellulose (NFC), microcrystalline cellulose (MCC), nanocrystalline cellulose (NCC), and combinations thereof, with a functional agent, the formulations provided improved retention, reactivity, and/or distribution of the functional agents to a substrate.

Microfibrillated cellulose (MFC) and nanofibrillated cellulose (NFC) are produced from cellulose pulp via mechanical grinding and have an extraordinarily high surface area and a unique interpenetrated network structure. Microcrystalline cellulose (MCC) and nanocrystalline cellulose (NCC) are also refined wood pulp and can be synthesized by combining different processes such as reactive extrusion, mechanical grinding, ultrasonication, steam explosion, with enzymatic and/or acid hydrolysis techniques. The later processes can be done by cellulolytic enzymes such as endo-1,4-D-glucanase, glucosidase, exo-1,4-D-glucanase, or by using mineral acids such as H₂SO₄, HCl and HBr as well as ionic liquids. The role of these reagents is to destroy the amorphous regions leaving the crystalline domains. During pulping, treatment, and refining of the fiber, the obtained nanocellulose is usually characterized by a high surface area, abundance of reactive hydroxyl groups (—OH), and presence of anionic surface charges (e.g., R—COO⁻, or R—O—SO₃⁻). For purposes of this application, the use of the term nanocellulose is meant to include cellulose defined as microfibrillated cellulose (MFC) or cellulose microfibril (CMF), nanofibrillated cellulose (NFC) or cellulose nanofibril (CNF), microcrystalline cellulose (MCC) or cellulose microcrystal (CMC), nanocrystalline cellulose (NCC) or cellulose nanocrystal (CNC), and combinations thereof.

Although not to be bound by theory, it is believed that nanocelluloses having abundant reactive hydroxyl groups (—OH) and anionic surface charges (e.g. R—COO⁻, or R—O—SO₃⁻) that the anionic charge and reactive hydroxyl groups on the fiber surface interact and/or react with the functional agents to provide a more uniform distribution of the functional agents and/or more covalently bound functional agents to fibers on a substrate in dry molding processes. It is believed that the anionic surface charges interact with cationic sizing or barrier agents to improve retention of the functional agents on a substrate while the reactive hydroxyl groups on the fiber surface ensures a high reactivity towards the sizing agents and/or barriers thereby providing more covalent bonds forming between fibers and the functional agents.

It was found through extensive study that the presence of nanocellulose in an aqueous dispersion containing one or more functional agents was found to significantly improve retention, reactivity, and/or distribution of functional agents.

The composition is useful in applications where an aqueous dispersion of one or more functional agents is used to impart barrier properties such as, water resistance, water vapor resistance, oil and grease resistance, gas (e.g., oxygen) resistance, or other barrier properties to substrates and articles used in applications such as, dry molding or dry forming processes.

Accordingly, it is an objective to provide barrier compositions, coatings, and formulations having enhanced retention, reactivity, and/or distribution of functional agents on a substrate, such as in dry molding applications, and thus providing better barrier properties than are currently available.

Furthermore, other desirable features and characteristics of the present disclosure will become apparent from the subsequent detailed description and the appended claims and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Provided is a barrier composition that improves retention, reactivity, or distribution of functional agents to a surface of a substrate. The composition includes one or more nanocelluloses, for example, microfibrillated cellulose (MFC), cellulose microfibril (CMF), nanofibrillated cellulose (NFC), cellulose nanofibril (CNF), microcrystalline cellulose (MCC), cellulose microcrystal (CMC), nanocrystalline cellulose (NCC), cellulose nanocrystal (CNC), and combinations thereof; an aqueous dispersion of one or more functional agents; and water.

Also provided is a substrate made up of dry cellulose fibers having improved barrier properties comprising a substrate of a three-dimensional (3D) structure of cellulose fibers having a first and second surface disposed opposite one another, and a barrier layer disposed on the cellulose fibers in the 3D structure, and/or in direct contact with the outermost surface, the innermost surface, or both surfaces of the substrate.

The barrier layer comprises a composition that includes an aqueous dispersion of one or more functional agents and one or more nanocelluloses, such as those chosen from microfibrillated cellulose (MFC), cellulose microfibril (CMF), nanofibrillated cellulose (NFC), cellulose nanofibril (CNF), microcrystalline cellulose (MCC), cellulose microcrystal (CMC), nanocrystalline cellulose (NCC), cellulose nanocrystal (CNC), and combinations thereof.

Also, provided is a method for improving retention, reactivity, or distribution of functional agents to a substrate. The method includes providing a substrate having a three-dimensional (3D) structure of cellulose fibers with an outermost surface and an innermost surface disposed opposite one another, and applying or otherwise disposing a barrier composition onto the cellulose fibers in the 3D structure of the substrate, and/or the outermost surface, the innermost surface, or both surfaces of the substrate. The barrier composition includes an aqueous dispersion of one or more functional agents and one or more nanocellulose(s).

Finally, the article produced by the compositions and methods described herein.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims.

Furthermore, there is no intention to be bound by any expressed or implied theory presented in the preceding technical field, background, brief summary, or the following detailed description.

Unless specifically stated or obvious from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

As used herein, the term “paper” refers to paper products including tissue paper, paper towels, paper and paperboard, and molded fiber/pulp products.

Provided is a composition that includes an aqueous dispersion of one or more functional agents, and one or more nanocelluloses.

In some aspect of the barrier composition, the one or more functional agents can be chosen from, for example, sizing agents, barrier agents, and combinations thereof.

In some aspects of the barrier composition, the one or more functional agents can be a sizing agents chosen from alkyl ketene dimer (AKD), alkenyl ketene dimer (AnKD), alkenyl succinic anhydride (ASA), rosins, such as free rosins, fortified rosins, and cationic rosins, and combinations thereof.

In some aspects of the barrier composition, the sizing agent can be present in an amount of from about 0.01 wt. % to about 50 wt. % of the barrier composition, or from about 0.01 wt. % to about 15 wt. % of the barrier composition.

In other aspects of the barrier composition, the functional agent is a barrier agent selected from wax dispersions, latexes, natural polymer solutions or dispersions, and combinations thereof.

In some aspects of the barrier composition, the barrier agent is present in an amount of from greater than 0 wt. % up to about 50 wt. % of the barrier composition, or from about 0.5 wt. % to about 30 wt. % of the barrier composition.

In some aspects of the barrier composition, the nanocellulose can be chosen from microfibrillated cellulose (MFC), cellulose microfibril (CMF), nanofibrillated cellulose (NFC), cellulose nanofibril (CNF), microcrystalline cellulose (MCC), cellulose microcrystal (CMC), nanocrystalline cellulose (NCC), cellulose nanocrystal (CNC), and combinations thereof.

In some aspects of the barrier composition, the nanocellulose is present in an amount of from about 5 wt. % to about 99.9 wt. %, can be present in an amount of from about 10 wt. % to about 85 wt. %, and may be present in an amount of from about 20 wt. % to about 70 wt. % of the barrier composition.

In yet other aspects of the barrier composition, the one or more functional agents can be in a neutral, cationic, or anionic emulsion system, and the sizing agents and the barrier agents have same type of electrical charges, preferably the functional agents are in a neutral or cationic emulsion system.

In yet other aspects of the barrier composition, the one or more nanocellulose can be in suspension, wherein the suspension has a pH of from about 6 to about 10, and can be from about 7.5 to about 8.5.

In some aspects of the barrier composition, the nanocellulose has a BET surface area of at least about 5 m²/g, and can be at least about 10 m²/g. The BET surface area is calculated from a N₂ adsorption curve by Brunauer-Emmet-Teller (BET) method according to ISO 9277: 2010 for dried nanocellulose fibers prepared by solvent exchange followed by supercritical CO₂ drying.

In other aspects of the barrier composition, the average fiber width of the nanocellulose is below 1 micron, and can be below 0.1 micron as measured by an election microscope.

In some aspects of the barrier composition, the nanocellulose is present in a suspension or in a paste.

In some aspects of the barrier composition, the nanocelluloses and the functional agents are present in a mass ratio based on dry matter of greater than about 1:1 or greater than about 10:1 to 1:10, respectively.

In other aspects of the barrier composition, the barrier agents can be chosen from any of the known barrier agents in the industry, for example, a wax dispersion, wherein a wax selected from the group consisting of a paraffin, microcrystalline, polyethylene, polypropylene, Fischer-Tropsch, montan, palm, palm kernel, coconut, rapeseed, soybean, safflower, corn, sunflower, castor, carnauba, beeswax, shellac, candelilla, sugar cane, rice bran, stearates, laurates, oleates, ethylene-vinyl acetate copolymer (EVA), ethylene-propylene copolymer, and combinations thereof.

In other aspects of the barrier composition, the barrier agents further comprise a thermoplastic polymer chosen from hydrocarbon resins, polypropylene and propylene copolymers, polyethylene and ethylene copolymers, polystyrene and styrene copolymers, polyesters, styrene-maleic anhydride copolymers, derivatives, vinyl acetate-butyl acrylate copolymers, acrylic acid-methyl methacrylate copolymers, polyhydroxyalkanoates, polyhydroxybutyrates, styrene-butadiene copolymers, styrene-acrylate copolymers, butadiene-methyl methacrylate copolymers, polybutadienes and combinations thereof.

In yet other aspects of the barrier composition, the composition can further comprise additional additives, such as a natural polymer solution or dispersion. For example, starches, celluloses, lignins, hemicelluloses, pectins, proteins, rosins, such as, free rosin, fortified rosin, cationic rosin, rosin esters, and rosin amides, polyterpenes, alginates, xanthan gum, soy lecithin, lipids, disaccharides, monosaccharides, their derivatives (esterified-, cationic-, and carboxylated natural polymers), and combinations thereof.

Also provided is a method of improving retention, reactivity, or distribution of functional agents disposed on a substrate is provided. The method comprising the steps of providing the substrate having a substrate surface and comprising a fiber having a fiber surface; and disposing a barrier composition on and in direct contact with the fiber surface and/or the surface of the substrate wherein the barrier composition comprises an aqueous dispersion comprising one or more functional agents, and one or more nanocelluloses.

In some aspects of the method, the substrate can be a dry molded article and/or comprises a raw material and/or intermediate material used in a dry molding or a dry forming process.

In some aspects of the method, the one or more functional agents can be for example, an alkyl ketene dimer (AKD), alkenyl ketene dimer (AnKD), alkenyl succinic anhydride (ASA), rosin sizing, such as free rosin, fortified rosin, cationic rosin, wax dispersions, latexes, natural polymer solutions, polymer dispersions, and combinations thereof.

In some aspects of the method, the one or more functional agents comprise from about greater than 0 wt. % up to about 50 wt. %, or 0.01 wt. % to about 30 wt. %, or about 0.5 wt. % to about 15 wt. % of the barrier composition.

In some aspects of the method, the nanocellulose can be chosen from microfibrillated cellulose (MFC), cellulose microfibril (CMF), nanofibrillated cellulose (NFC), cellulose nanofibril (CNF), microcrystalline cellulose (MCC), cellulose microcrystal (CMC), nanocrystalline cellulose (NCC), cellulose nanocrystal (CNC), and combinations thereof.

In some aspects of the method, the substrate can be chosen from non-cellulose and cellulose fiber-based materials. For example the substrate can be chosen from mechanical pulp, chemomechanical pulp, chemical pulp, wood, non-wood plants, such as non-wood plants are chosen from bagasse, linters, cotton, miscanthus, grass, flax, hemp, jute, kenaf, bamboo, ramie, and sisal, sugar beet, fruits, tomato stems, agricultural materials, for example, bagasse, linter and cotton, miscanthus, grass, hemp fiber, and tomato greens. Other substrates include paper, paperboard, fiber, molded fibers, fibrils, cellulose fiber, regenerated cellulose, aramid, glass, carbon, polyester, wool, silk, and combinations thereof. Non-cellulose substrates can, from example, aramids, glass, carbon, polyesters, wool, silk, and combinations thereof.

In some aspects of the method, the substrate can be in form of fibers, paper, paperboard, molded fiber articles such as thick-wall, transfer, thermoformed (thin-wall), and processed articles, and molded paper/paperboard articles.

In yet other aspect of the method, the substrate can also be chosen from a nanocellulose chosen from microfibrillated cellulose (MFC), cellulose microfibril (CMF), nanofibrillated cellulose (NFC), cellulose nanofibril (CNF), microcrystalline cellulose (MCC), cellulose microcrystal (CMC), nanocrystalline cellulose (NCC), cellulose nanocrystal (CNC), and combinations thereof.

In yet other aspects of the method, the method includes providing a substrate having a three-dimensional (3D) structure of fibers, fibrils, and/or paper, wherein the fibers, fibrils, and/or paper that are present in a network defining a plurality of air voids.

In this respect, the composition being disposed on or applied to the surface of the substrate, coats the fibers, fibrils, and/or paper thereby reducing or eliminating the air voids of the substrate having the three-dimensional structure.

In other aspects of the method, the composition is applied or disposed on the fiber surface and/or surface of the substrate by any technique suitable to distribute a liquid formulation onto dry fiber/paper/paperboard, such as spraying, dipping, brushing, and combinations thereof.

Finally, provided is the article produce from the method described above.

### EXAMPLES

### Example 1—Preparation of the Barrier Formulation

In a first step, suspensions of a microfibrillated cellulose (MFC) (0.5-1.5 wt. %) and microcrystalline cellulose (MCC) (0.5-6.0 wt. %) were prepared by diluting a concentrated MFC and MCC paste, respectively, in water using an Ultra Turrax blender to the desired concentration. The pH of the MFC and MCC suspensions were adjusted to a pH of 6.5 to 8.5, as necessary.

In a second step, 200 μL AKD water dispersion (dry content of about 20 wt. %) sizing agent was added to the MFC and MCC suspensions prepared in the first step, and the suspensions mixed at 500-5000 rpm for 1 minute producing the barrier composition to be applied to the substrate.

The composition was sprayed onto the surface of cellulose fibers in a dry molding process. The coated substrate or article was then cured at a temperature of 100° C.-150° C. for from 1 to 10 hours.

### Example 2—MFC as a Carrier Polymer for AKD Sizing

0.5 wt. % AKD dispersion (dry content of about 20 wt. %) was combined with samples of 20 grams (g), 40 grams, and 80 grams of a microfibrillated cellulose (1.3 wt. % MFC, pH 6.5). The suspension was mixed in a standard laboratory mixer and sprayed onto the surface of a fluffy cellulose mat (14 cm*14 cm, 600 gsm) using an air-assisted spray gun. After spraying, the samples were dried in an oven at 105° C. for 5 minutes. After drying, the samples were pressed using a carver press at 150° C. for 5 minutes under a force of 10 metric tons. A reference sample was also prepared using 40 grams water (pH 6.5) as a carrier without MFC for comparison. A 2 hour post curing was performed at the end of the process at 120° C. The % bound AKD and % recovered AKD/added AKD was determined by gas chromatography-mass spectrometry (GC/MS) method and the results are shown in Table 1 below.

TABLE 1
% bound AKD and % recovered AKD/added AKD

| | | % Recovered |
|---|---|---|
| Sample | % Bound AKD | AKD/Added AKD |
| (1) Blank (without MFC) | 27.5 | 43.4 |
| (2) Blank + 20 g 1.3% MFC | 28.6 | 29.8 |
| (3) Blank + 40 g 1.3% MFC | 36.7 | 43.4 |
| (4) Blank + 80 g 1.3% MFC | 45.7 | 33.3 |

Results indicate that 1) the % bound AKD increases with an increase in MFC addition; and 2) the % recovered AKD/added AKD has no improvement using MFC as a carrier.

### Example 3—MCC as a Carrier Polymer for AKD Sizing

0.5 wt. % AKD dispersion (dry content of about 20 wt. %) was added to 40 g (6.0 wt. % MCC, pH 8.0). The mixture was mixed well and sprayed onto the surface of a fluffy cellulose mat (14 cm×14 cm, 600 gsm) using an air-assisted spray gun. After spraying, the samples were dried in an oven at 105° C. for 5 minutes. After drying, the samples were pressed using a carver press at 150° C. for 5 minutes under a force of 10 metric tons. A reference sample was also prepared using 40 grams of water (pH 6.5) as a carrier without MFC in the mixture. A two hour post curing was performed on % bound AKD and % recovered AKD/added AKD are shown in Table 2 below.

TABLE 2
Percent Bound AKD and Percent Recovered AKD/Added AKD

| | | % Recovered |
|---|---|---|
| Sample | % Bound AKD | AKD/Added AKD |
| (1) Blank (without | 27.5 | 43.4 |
| MCC) | | |
| (2) Blank + 40 g 6.0% | 42.9 | 65.6 |
| MCC 10377 | | |
| (3) Blank + 20 g 1.3% | 28.6 | 29.8 |
| MFC | | |
| (4) Blank + 20 g 1.3% | 45.8 | 56.3 |
| MFC/20 g 6.0% MCC | | |

Results indicate that 1) the % bound AKD increases up to 43% when MCC is added as a carrier; 2) the impact of 40 g 6.0% MCC on % bound AKD is nearly equivalent to 80 g 1.3% MFC; and 3) the addition of MCC shows a positive impact on % recovered AKD/added AKD;

In addition, considering the low cost and low viscosity of MCC vs. MFC, using MCC as a carrier system for AKD sizing agents exhibits more advantages compared to MFC (i.e., low cost and lost amount of water to introduce to dry molding process).

MFC combined with MCC provides synergistic effects of % bound AKD and AKD recovery rate, and 20 grams of 6% MCC added on top of 20 grams of 1.3% MFC increases % bound AKD and % Recovered AKD/added AKD by 60% and 89%, respectively.

The bound AKD increases up to 66% when using MFC and/or MCC as carrier polymers. The recovered AKD (i.e., % Recovered AKD/added AKD) increases by 51% using MCC as a carrier polymer, which indicates an improved AKD distribution in the molded articles.

While at least one exemplary embodiment has been presented in the foregoing detailed description and examples of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A barrier composition comprising:
an aqueous dispersion comprising one or more functional agents, and
one or more nanocellulose.

2. The barrier composition according to claim 1, wherein each of the one or more functional agents is chosen from sizing agents, barrier agents, and combinations thereof.

3. The barrier composition according to claim 1, wherein the functional agent is a sizing agent is chosen from alkyl ketene dimers (AKD), alkenyl ketene dimers (AnKD), alkenyl succinic anhydrides (ASA), rosins, and combinations thereof.

4. The barrier composition according to claim 3, wherein the sizing agent is present in an amount of from about 0.01 wt. % to about 50 wt. % of the barrier composition, or from about 0.01 wt. % to about 15 wt. % of the barrier composition.

5. The barrier composition according to claim 1, wherein the functional agent is a barrier agent chosen from wax dispersions, latexes, natural polymer solutions, polymer dispersions, and combinations thereof.

6. The barrier composition according to claim 1, wherein the barrier agent is present in an amount of from greater than 0 wt. % up to about 50 wt. % of the barrier composition, or from about 0.5 wt. % to about 30 wt. % of the barrier composition.

7. The barrier composition according to claim 1, wherein the nanocellulose is chosen from microfibrillated cellulose (MFC), cellulose microfibril (CMF), nanofibrillated cellulose (NFC), cellulose nanofibril (CNF), microcrystalline cellulose (MCC), cellulose microcrystal (CMC), nanocrystalline cellulose (NCC), cellulose nanocrystal (CNC), and combinations thereof.

8. The barrier composition according to claim 1, wherein the nanocellulose is present in an amount of from about 5 wt. % to about 99.9 wt. %, or from about 10 to about 85 wt. %, or from about 20 wt. % to about 70 wt. % of the barrier composition.

9. The barrier composition according to claim 1, wherein the nanocellulose is present in a suspension or in a paste that has a pH of from about 5 to about 10 or from about 5.5 to about 8.5.

10. The barrier composition according to claim 1, wherein the nanocellulose has a BET surface area of at least about 5 m²/g, or at least about 10 m²/g.

11. The barrier composition according to claim 1, wherein the nanocellulose has an average fiber width less than about 1 micron, or less than about 0.1 micron.

12. The barrier composition according to claim 1, wherein the nanocellulose is present in a suspension or in a paste.

13. The barrier composition according to claim 1, wherein the nanocellulose and the functional agent are present in a mass ratio based on dry matter of greater than about 1:1 or greater than about 10:1 to 1:10, respectively.

14. The barrier composition according to claim 1, further comprising a thermoplastic polymer chosen from hydrocarbon resins, polypropylene and propylene copolymers, polyethylene and ethylene copolymers, polystyrene and styrene copolymers, polyesters, styrene-maleic anhydride copolymers and their salts, and combinations thereof.

15. A method of improving retention, reactivity, and/or distribution of functional agents disposed on a fiber surface and/or substrate, the method comprising the steps of:
providing the substrate having a substrate surface and comprising a fiber having a fiber surface; and
disposing a barrier composition according to claim 1, on and in direct contact with the fiber surface and/or the surface of the substrate.

16. The method according to claim 15, wherein the substrate is a dry molded article and/or comprises a raw material and/or intermediate material used in a dry molding or a dry forming process.

17. The method according to claim 15, wherein the composition is disposed on the fiber surface and/or substrate by spraying, dipping, brushing, or any other techniques to apply a barrier composition to a substrate.

18. The method according to claim 15, wherein the substrate is chosen from non-cellulose and cellulose fiber-based materials.

19. A substrate according to claim 15, wherein the substrate comprises a three-dimensional (3D) structure of fibers, fibrils, and/or paper, wherein the fibers, fibrils, and/or paper are present in a network defining a plurality of air voids.

20. The article produced according to the method of claim 15.
